(19) United States
(12) Patent Application Publication
(10) Pub. No.: US 2025/0284837 A1
(43) Pub. Date: Sep. 11, 2025

(54) ELECTRONIC DEVICE FOR MANAGING ACCESS TO AN APPLICATION AND METHOD THEREOF

(71) Applicant: SAMSUNG ELECTRONICS CO., LTD., Suwon-si (KR)

(72) Inventors: Anish SINGHANIA, West Bengal (IN); Mohamed Akram Ulla SHARIFF, Bangalore (IN); Parameswaranath Vadackupurath MANI, Thuravoor (IN); Pavan Kumar PANAKALAPATI, Bangalore (IN); Siva Prasad THOTA, Bangalore (IN); Bhanu Prakash BOMMA, Bangalore (IN); Atikant SINGH, Bangalore (IN); Sreenath DINDUKURTHI, Bangalore (IN); Barath Raj KANDUR RAJA, Bangalore (IN); Dwaraka Bhamidipati SREEVATSA, Bangalore (IN); Vanraj VALA, Bangalore (IN)

(73) Assignee: SAMSUNG ELECTRONICS CO., LTD., Suwon-si (KR)

(21) Appl. No.: 19/219,304

(22) Filed: May 27, 2025

Related U.S. Application Data
(63) Continuation of application No. PCT/KR2023/007212, filed on May 25, 2023.

(30) Foreign Application Priority Data
Dec. 26, 2022 (IN) 202241075664

(51) Int. Cl. G06F 21/62

(52) U.S. Cl. CPC G06F 21/6218

(57) ABSTRACT

A method for managing access to content for an application of an electronic device includes receiving, from the application, a content access request for granting access to first data of one or more content types available via the electronic device; displaying one or more labels, from among a plurality of labels, corresponding to the one or more content types; receiving a first user selection of at least one label, from among the one or more labels, corresponding to the one or more content types; and granting, to the application, access to the first data of the one or more content types based on the first user selection.

### CROSS-REFERENCE TO RELATED APPLICATIONS

This application is a by-pass continuation application of International Application No. PCT/KR2023/007212, filed on May 25, 2023, which is based on and claims priority to Indian Patent Application number 202241075664, filed on Dec. 26, 2022, in the Indian Patent Office, the disclosures of which are incorporated by reference herein in their entireties.

### 1. FIELD

The present disclosure relates to methods and systems for access management in mobile devices and more particularly, to managing access of content and/or sensors for an application in the electronic device.

### 2. DESCRIPTION OF RELATED ART

With rapid development in smartphones and associated third-party applications, users are increasingly concerned about privacy and data misuse. Multiple incidents of such blatant misuse of data are reported on a daily basis, which trigger a huge concern regarding privacy among users. Some techniques are implemented to address this problem by introducing more restrictions in allowing data access to installed applications. Operating systems have introduced methods to revoke permissions of applications which are not in use by the user. Such methods have also restricted background access by such applications.

Systems may not provide permission models for the applications which are more in control of users. Existing techniques may fail to provide protection against application synchronizing private data to a server without user's knowledge. Such a system fails to provide transparency to the user regarding content being accessed by the applications.

There is therefore a need for a technology capable of facilitating permission handling for applications that may increase privacy protection and may reduce data misuse.

### SUMMARY

According to an aspect of the disclosure, a method for managing access to content for an application of an electronic device includes, receiving, from the application, a content access request for granting access to first data of one or more content types available via the electronic device; displaying one or more labels, from among a plurality of labels, corresponding to the one or more content types; receiving a first user selection of at least one label, from among the one or more labels, corresponding to the one or more content types; and granting, to the application, access to the first data of the one or more content types based on the first user selection.

The method may further include displaying one or more sub-labels based on the first user selection; receiving a second user selection of at least one sub-label, from among the one or more sub-labels, corresponding to at least one of the one or more content types; and granting, to the application, access to second data of the at least one of the one or more content types based on the second user selection.

The one or more content types may include at least one of images, videos, text messages, electronic device information, or sensor data.

The method may further include monitoring a content type of second data accessed by the application; determining whether the content type deviates from the access granted; detecting a spurious access by the application based on the content type deviating from the access granted; and displaying a notification indicating the spurious access.

The method may further include determining an application type based on metadata associated with the application; and restricting the access to second data from among a set of one or more content types based on the application type.

The method may further include receiving, from the application, a sensor access request to access one or more sensors of the electronic device; determining second data corresponding to the sensor access request by the application; determining whether the second data complies with a predefined criteria for accessing the one or more sensors; and providing, to the application, access to the one or more sensors based on determining that the second data complies with the predefined criteria.

The method may further include monitoring the access to the one or more sensors by the application; determining whether the application is in use by a user of the electronic device while the one or more sensors are being accessed by the application; and based on determining the application is not in use, restricting the access to the one or more sensors by the application.

The method may further include displaying a notification based on the application not being in use by the user while the one or more sensors are being accessed by the application.

The method may further include generating pseudo content based on the one or more content types; and providing the application access to the pseudo content.

According to an aspect of the disclosure, an electronic device for managing access to content for an application, the electronic device includes memory storing instructions; and at least one processor; wherein the instructions, when executed by the at least one processor, may cause the electronic device to receive, from the application, a content access request for granting access to first data of one or more content types available via the electronic device; display one or more labels, from among a plurality of labels, corresponding to the one or more content types; receive a first user selection of at least one label, from among the one or more labels, corresponding to the one or more content types; and granting, to the application, access to the first data of the one or more content types based on the first user selection.

The instructions, when executed by the at least one processor, may cause the electronic device to display one or more sub-labels based on the first user selection; receive a second user selection of at least one sub-label, from among the one or more sub-labels, corresponding to at least one of the one or more content types; and grant, to the application, access to second data of the at least one of the one or more content types based on the second user selection.

The one or more content types may include at least one of images, videos, text messages, electronic device information, or sensor data.

The instructions, when executed by the at least one processor, may cause the electronic device to monitor a content type of second data accessed by the application; determine whether the content type deviates from the access granted; detecting a spurious access by the application based on the content type deviating from the access granted; and display a notification indicating the spurious access.

The instructions, when executed by the at least one processor, may cause the electronic device to determine an application type based on metadata associated with the application; and restrict the access to second data from among a set of one or more content types based on the application type.

The instructions, when executed by the at least one processor, may cause the electronic device to receive, from the application, a sensor access request to access one or more sensors of the electronic device; determine second data corresponding to the sensor access request by the application; determine whether the second data complies with a predefined criteria for accessing the one or more sensors; and provide, to the application, access to the one or more sensors based on determining that the second data complies with the predefined criteria.

### BRIEF DESCRIPTION OF THE DRAWINGS

The above and other aspects, features, and advantages of certain embodiments of the present disclosure are more apparent from the following description taken in conjunction with the accompanying drawings, in which:

FIG. 1 illustrates a block diagram of an electronic device implementing access management for an application, according to an embodiment;

FIG. 2 illustrates a schematic block diagram of the electronic device for managing access to an application, according to an embodiment;

FIG. 3 illustrates a schematic architecture of the electronic device, including a system for managing access for an application in the electronic device, according to an embodiment;

FIG. 4 illustrates a block diagram of a content aware privacy module, according to an embodiment;

FIG. 5 illustrates a flow chart of a method of adding content, according to an embodiment;

FIG. 6 illustrates a flow chart of a method of querying content by an application, according to an embodiment;

FIG. 7 illustrates a flow chart of a method of adding content, according to another embodiment;

FIG. 8 illustrates a flow chart of a method of querying content by an application, according to another embodiment;

FIG. 9 illustrates a flow chart of a method for permission management of an application, according to an embodiment;

FIG. 10 illustrates a flow chart of a method of label prediction, according to an embodiment;

FIG. 11 illustrates a flow chart of a method of label training, according to an embodiment;

FIG. 12 illustrates a flow chart of a method of anomaly detection, according to an embodiment;

FIG. 13 illustrates a flow chart of a method for rendering a user interface (UI), according to an embodiment;

FIG. 14 illustrates a flow chart of a method for cleaning content, according to an embodiment;

FIG. 15A illustrates a flow chart of a method for managing access of content to an application in the electronic device, according to an embodiment;

FIG. 15B illustrates a flow chart of a method for managing access of content to an application in the electronic device, according to an embodiment;

FIG. 15C illustrates a flow chart of a method for managing access of content to an application in the electronic device, according to an embodiment;

FIG. 16A illustrates a flow chart of a method for managing access of content for an application in the electronic device, according to another embodiment;

FIG. 16B illustrates a flow chart of a method for managing access of content for an application in the electronic device, according to another embodiment;

FIG. 16C illustrates a flow chart of a method for managing access of content for an application in the electronic device, according to another embodiment;

FIG. 16D illustrates a flow chart of a method for managing access of content for an application in the electronic device, according to another embodiment;

FIG. 17 illustrates generation of labels for a content access request by a messaging application, according to an embodiment;

FIG. 18 illustrates recommendation of labels for media access requests by an application, according to an embodiment;

FIG. 19 illustrates recommendation of labels for media access requests by an application, according to another embodiment;

FIG. 20 illustrates learning recommendation, according to an embodiment; and

FIG. 21 illustrates a comparison of clipboard content access according to a technique and an embodiment.

### DETAILED DESCRIPTION

The embodiments described in the disclosure, and the configurations shown in the drawings, are only examples of embodiments, and various modifications may be made without departing from the scope and spirit of the disclosure.

It will be understood by those skilled in the art that the foregoing description and the following detailed description are explanatory of the disclosure and are not intended to be restrictive thereof.

The elements shown in the drawings may not have necessarily been drawn to scale. For example, the flow charts illustrate the method in terms of operations involved to help to improve understanding of aspects of the present disclosure. In terms of the construction of the device, one or more components of the device may have been represented in the drawings by symbols, and the drawings may show only those details that are pertinent to understanding the embodiments of the present disclosure so as not to obscure the drawings with details that will be readily apparent to those of ordinary skill in the art having the benefit of the description herein.

Reference to “an aspect”, “another aspect” or similar language means that a feature, structure, or characteristic described in connection with the embodiment is included in at least one embodiment of the present disclosure. Appearances of the phrase “in an embodiment”, “in another embodiment” and similar language may, but do not necessarily, all refer to the same embodiment.

The terms “comprises”, “comprising”, or any other variations thereof, are intended to cover a non-exclusive inclusion, such that a process or method that comprises a list of operations does not include only those operations but may include other operations not expressly listed or inherent to such process or method. One or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The expressions “at least one of A, B and C” and “at least one of A, B, or C”, both indicate “A”, only “B”, only “C”, both “A and B”, both “A and C”, both “B and C”, and all of “A, B, and C”.

The terms “mobile device”, “electronic device” and “smartphone” may be used interchangeably throughout the description.

To solve the above-mentioned problems, the present disclosure discloses a mechanism to manage access of content and/or sensors by an application installed within a mobile device of the user. The present disclosure enables the user to effectively manage permission of content and sensors for the application.

According to various embodiments, a method and system for managing access of content for an application in an electronic device is provided. The method includes receiving a request for accessing content by the application, then providing labels associated with the content requested by the user. The method includes receiving user selection of labels and providing access to the application based on the received user selection.

In some embodiments, the method may also include receiving a sensor access request from the application. In such scenarios, the method includes providing the access to the sensors if the sensor access request complies with a set of predefined rules.

The technique provided by the present disclosure may facilitate access management for an application to protect user privacy and data.

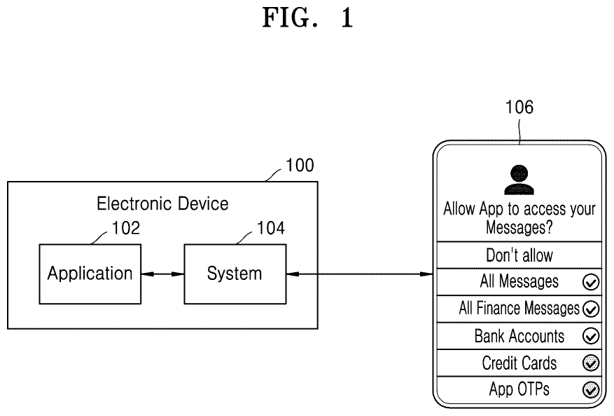

FIG. 1 illustrates a block diagram of an electronic device 100 implementing access management for an application 102, according to an embodiment. Examples of the electronic device 100 may include, but not limited to, smartphones, tablets, laptops, portable computing devices, and so forth. The application 102 may be installed in the electronic device 100. The application 102 may correspond to a software configured to implement functionality of the electronic device 100. Examples of the application 102 (may also be referred as “app 102”) may include, but not limited to, a camera application, a messaging application, a web browsing application, an image editing application, a social media application and so forth. In some embodiments, the application 102 may use some data and/or access to one or more sensor(s) of the electronic device 100 to implement the desired functionality. For example, a social media application may request access to image content stored in the electronic device 100 to enable the user to share the stored images over a social media platform. The social media application may request access to the image sensor of the electronic device 100 to enable the user to capture an image and share the captured image over the social media platform.

To access the content and/or the sensors, the application 102 may generate a request. The application 102 may generate a content access request to access different content types stored in the electronic device 100. The content types may include, but not limited to, images, videos, text messages, electronic device information, and sensors-related data. The application 102 may generate a sensor access request to access sensor(s) of the electronic device 100. In an embodiment, each of the content access request and the sensor access request may be sent to a system 104 for approval of such access requests.

In an embodiment, the system 104 may be installed within the electronic device 100. In an embodiment, the system 104 may be a part of an operating system of the electronic device 100. The system 104 may be a standalone entity located remotely to the electronic device 100. In such condition, the system 104 may be communicably coupled to the electronic device 100 via wireless and/or wired means.

In an embodiment, the system 104 may be configured to receive the content access request and the sensor access request generated by the application 102. In an embodiment, the content may be associated with different labels. The system 104 may be configured to store different labels for different content types. In an embodiment, the labels may correspond to names of semantic categories in which the content may be categorized. For example, for images, the labels may include, but not limited to, private and public, or vacation, family, friends and so forth. For messages, the labels may include, but not limited to, financial messages, personal messages, One Time Passwords (OTPs) messages and so forth. In some embodiments, the content may be categorized into semantic categories using on-device Machine Learning (ML) model and/or collaborative learning. In an embodiment, the system 104 may be configured to provide one or more labels from a plurality of labels corresponding to each of content types requested by the application in the content access requests. For example, if the application request access for images. The system 104 may be configured to provide labels corresponding to image media to the user. Such labels may be provided to the user via a user interface (UI) 106 displayed over a display of the electronic device 100. In an embodiment, the labels corresponding to image media may include, but not limited to, vacation, group, solo, private, friend, family and so forth. If the application 102 requests access to messages, the system 104 may provide labels such as, but not limited to, finance messages, bank accounts, credit cards, and application One Time Passwords (OTP), as shown in FIG. 1. The system 104 may also provide an option to restrict access to any type of messages or to allow access to all types of messages.

The system 104 may be configured to receive user selection of label(s) from the UI 106 accessible to the user. For example, for the access content request corresponding to messages, the user may only select labels “credit cards” and “App OTPs”, as shown in FIG. 1.

The system 104 may be configured to provide content access to the application based on the user selection. The system 104 may restrict access to content for the application 102 which corresponds to labels which are not selected by the user.

In case of sensor access request, the system 104 may determine whether the received sensor access request complies with a predefined criteria and may only provide access to the sensors upon successfully determining that the sensor access request complies with the predefined criteria. In an embodiment, the predefined criteria may be, but not limited to, a relationship of sensors and different type of application(s), conditions for usage of sensors and so forth. For example, a voice recording application may not be provided access to the camera sensor of the electronic device 100. In some embodiments, the system 104 may enable a user to select when to allow usage of the sensor by the application 102. For example, the system 100 may enable the user to allow the application 102 to access the sensors only when the application 102 is in use.

The electronic device 100 may provide an effective access management technique for the application and protect user privacy and data misuse.

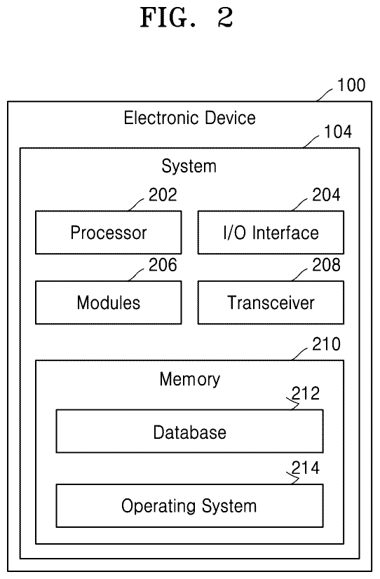

FIG. 2 illustrates a schematic block diagram of the system 104 for managing access for the application 102 in the electronic device 100, according to an embodiment. In an embodiment, the system 104 may be included within an electronic device 100 associated with the user. In another embodiment, the system 104 may be configured to operate as a standalone device or a system based in a server/cloud architecture communicably coupled to the electronic device 100. Examples of the electronic device 100 may include, but not limited to, a mobile phone, a smart watch, a laptop computer, a desktop computer, a Personal Computer (PC), a notebook, a tablet, a mobile phone, and or any other smart device.

The system 104 may be configured to receive access request(s) from the application 102 and provide access to the application 102 based on user selected criteria and/or predefined criteria. The system 104 may include a processor/controller 202, an Input/Output (I/O) interface 204, one or more modules 206, a transceiver 208, and a memory 210.

In an embodiment, the processor/controller 202 may be operatively coupled to each of the I/O interface 204, the modules 206, the transceiver 208 and the memory 210. In one embodiment, the processor/controller 202 may include at least one data processor for executing processes in Virtual Storage Area Network. The processor/controller 202 may include processing units, such as integrated system (bus) controllers, memory management control units, floating point units, graphics processing units, digital signal processing units, for example. In one embodiment, the processor/controller 202 may include a central processing unit (CPU), a graphics processing unit (GPU), or both. The processor/controller 202 may be one or more general processors, digital signal processors, application-specific integrated circuits, field-programmable gate arrays, servers, networks, digital circuits, analog circuits, combinations thereof, or other now known or later developed devices for analyzing and processing data. The processor/controller 202 may execute a software program, such as code generated manually (for example, programmed) to perform the desired operation.

The processor/controller 202 may be disposed in communication with one or more input/output (I/O) devices via the I/O interface 204. The I/O interface 204 may employ communication code-division multiple access (CDMA), high-speed packet access (HSPA+), global system for mobile communications (GSM), long-term evolution (LTE), WiMax, or the like.

Using the I/O interface 204, the system 104 may communicate with one or more I/O devices, the electronic devices associated with the human-to-human conversation. For example, the input device may be an antenna, microphone, touch screen, touchpad, storage device, transceiver, or video device/source, for example. The output devices may be a printer, fax machine, video display (e.g., cathode ray tube (CRT), liquid crystal display (LCD), light-emitting diode (LED), plasma, Plasma Display Panel (PDP), Organic light-emitting diode display (OLED) or the like), or audio speaker, for example. In an embodiment, the system 104 may communicate with the electronic device associated with the user using the I/O interface 204.

The processor/controller 202 may be disposed in communication with a communication network via a network interface. In an embodiment, the network interface may be the I/O interface 204. The network interface may connect to the communication network to enable connection of the system 104 with the outside environment and/or device/system. The network interface may employ connection protocols including, without limitation, direct connect, Ethernet (e.g., twisted pair 10/100/1000 Base T), transmission control protocol/internet protocol (TCP/IP), token ring, or IEEE 802.11a/b/g/n/x, for example. The communication network may include, without limitation, a direct interconnection, local area network (LAN), wide area network (WAN), wireless network (e.g., using Wireless Application Protocol), or the Internet, for example. Using the network interface and the communication network, the voice assistant device 201 may communicate with other devices. The network interface may employ connection protocols including, but not limited to, direct connect, Ethernet (e.g., twisted pair 10/100/1000 Base T), transmission control protocol/internet protocol (TCP/IP), token ring, or IEEE 802.11a/b/g/n/x, for example.

In an embodiment, the processor/controller 202 may receive the content access request from the application 102 to access one or more content types available at the electronic device 100. The processor/controller 202 may be configured to provide one or more labels corresponding to each one of the one or more content types requested by the application to a user of the electronic device 100. In an embodiment, the labels may correspond to semantic categories associated with content types. The semantic categories may be based on demographic profile of the user. The demographic profile of the user may be based on information such as, but not limited to, age, sex, race and user-interest. In some embodiments, a privacy profile corresponding to the user may be generated based on the demographic profile information of the user. The privacy profile may indicate user preference with respect to sharing of data and/or sensor access with different type of applications. In some embodiments, the content may be categorized into the semantic categories based on the user's privacy profile. In an embodiment, the processor/controller 202 may be configured to determine request related data corresponding to the content access request. The request related data may include information such as, but not limited to, a type of the application, a use of requested content by the application, an information associated with access provided to the application based on one or more previous requests, or an information associated with access provided to one or more applications similar to the application. The processor/controller 202 may provide the labels based on the determined request related data.

The processor/controller 202 may also be configured to receive a user selection of at least one label from the one or more labels corresponding to the one or more content types via the I/O interface 204. The processor/controller 202 may be configured to provide an access to the application 102 to the one or more content types requested by the application based on the user selection of label(s).

In some embodiments, the processor/controller 202 may be configured to provide one or more sub-labels based on the user selection of at least one label. For example, in case the application 102 requested access to images. Initially, the processor/controller 202 may provide labels such as, vacation, public, private or family and once the user selects a label, the processor/controller 202 may provide a set of sub-labels corresponding to the user selected label. For example, if a user selects vacation, the processor/controller 202 may provide sub-labels such as, official, social, solo, family, friends outing, international, and so forth. The processor/controller 202 may also be configured to receive a user selection of at least one sub-label from the presented sub-labels. The processor/controller may be configured to provide access to the application 102 to the one or more content types requested by the application 102 based on the user selection of the sub-label(s).

In some embodiments, the processor/controller 202 may be configured to monitor an actual content type access by the application 102. The processor/controller 202 may be configured to determine whether the actual content type is different from the provided access to the content type. In an example scenario, the application 102 may be provided with access to images categorized under the label “vacation”. Now, if the application 102 tries to access images categorized under labels other than “vacation”, such as, private or family, the processor/controller 202 may consider such access by the application 102 as a spurious access. The processor/controller 202 may generate an alert for the user and display the determined spurious access by the application 102. The processor/controller 202 may enable the user to take appropriate measures to stop spurious access by the application 102. For example, the user may uninstall the application 102 in case of determination of the spurious access by the application 102.

In some embodiments, the processor/controller 202 may be configured to determine a type of the application based on metadata associated with the application 102. Examples of different types of application may include, but not limited to, a gaming application, a social media application, a financial application, and so forth. The processor/controller 202 may be configured to restrict access to a set of content type for the application 102 based on the type of the application. For example, if the type of application is the social media application, the processor/controller 202 may restrict access to financial messages. The processor/controller 202 may generate a suggestion for the user to restrict access to content type based on the determined type of application.

In some other embodiments, the processor/controller 202 may be configured to receive a sensor access request from the application 102. The sensor access request may correspond to a request to access sensor(s) of the electronic device 100 by the application 102. The processor/controller 202 may be configured to determine sensor related data corresponding to the sensor access request by the application 102. The sensor related data may include information, such as, but not limited to, a type of sensor, an application of the sensor, and usage timing of the sensor and so forth. For example, the sensor related data may indicate that the application 102 intends to access a camera sensor (for example, the type of sensor) to capture an image (for example, the application of the sensor) while the user is accessing the application 102 (for example, usage timing of the sensor). The processor/controller 202 may be configured to determine whether the sensor related data complies with a predefined criteria to access the sensors or not. The predefined criteria may define rules relating to usage timing of sensors, access to sensors based on a type of application and associated application, and so forth. The predefined criteria may be defined by the system 104 or the user based on the suggestion from the system 104. Upon determining that the sensor request related data complies with the predefined criteria the processor/controller 202 may provide access to the requested sensors.

In an embodiment, the processor/controller 202 may be configured to monitor the access of the sensors by the application 102. The processor/controller 202 may be configured to determine whether the application 102 is in use by the user while accessing the one or more sensors and may restrict the access to the sensors by the application 102 upon determining that the application 102 is not in use by the user. In some embodiments, the processor/controller 202 may be configured to generate an alert for the user upon determining that the application is not in use while accessing the sensors. The alert may be provided to the user via the I/O interface 204 to enable the user to take appropriate measures to prevent such restricted access. The processor/controller 202 may protect user privacy and enhance protection against data misuse.

In an embodiment, the processor/controller 202 may also be configured to generate pseudo content based on the one or more content types requested by the application 102. The processor/controller 202 may provide access to such pseudo content when the application 102 requests for content. The processor/controller 202 enables a user to effectively test functionality of the application 102. By providing access to the pseudo content, the processor/controller 202 may enable the application 102 to operate and thereby the processor/controller 202 may implement effective monitoring of spurious access by the application 102.

In some embodiments, the memory 210 may be communicatively coupled to the at least one processor/controller 202. The memory 210 may be configured to store data, instructions executable by the at least one processor/controller 202. In one embodiment, the memory 210 may communicate via a bus within the system 104. The memory 210 may include, but not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 210 may include a cache or random-access memory for the processor/controller 202. The memory 210 may be separate from the processor/controller 202, such as a cache memory of a processor, the system memory, or other memory. The memory 210 may be an external storage device or database for storing data. The memory 210 may be operable to store instructions executable by the processor/controller 202. The functions, acts or tasks illustrated in the drawings or described may be performed by the programmed processor/controller 202 for executing the instructions stored in the memory 210. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing, and the like.

In some embodiments, the modules 206 may be included within the memory 210. The memory 210 may further include a database 212 to store data. The one or more modules 206 may include a set of instructions that may be executed to cause the system 104 to perform any one or more of the methods/processes disclosed herein. The one or more modules 206 may be configured to perform the operations using the data stored in the database 212, to determine semantic points in a human-to-human conversation as discussed herein. In an embodiment, each of the one or more modules 206 may be a hardware unit which may be outside the memory 210. The memory 210 may include an operating system 214 for performing one or more tasks of the system 104, as performed by an operating system in the communications domain. The transceiver 208 may be configured to receive and/or transmit signals to and from the electronic device associated with the user. In one embodiment, the database 212 may be configured to store the information by the one or more modules 206 and the processor/controller 202 to perform one or more functions for determining semantic points in a human-to-human conversation.

In an embodiment, the I/O interface 204 may enable input and output to and from the system 104 using devices such as, but not limited to, display, keyboard, mouse, touch screen, microphone, speaker and so forth.

The disclosure includes a non-transitory computer-readable medium that includes instructions or receives and executes instructions responsive to a propagated signal. The instructions may be transmitted or received over the network via a communication port or interface or using a bus. The communication port or interface may be a part of the processor/controller 202 or may be a separate component. The communication port may be created in software or may be a physical connection in hardware. The communication port may be configured to connect with a network, external media, the display, or any other components in the system, or combinations thereof. The connection with the network may be a physical connection, such as a wired Ethernet connection or may be established wirelessly. Likewise, the additional connections with other components of the system 104 may be physical or may be established wirelessly. The network may be directly connected to the bus.

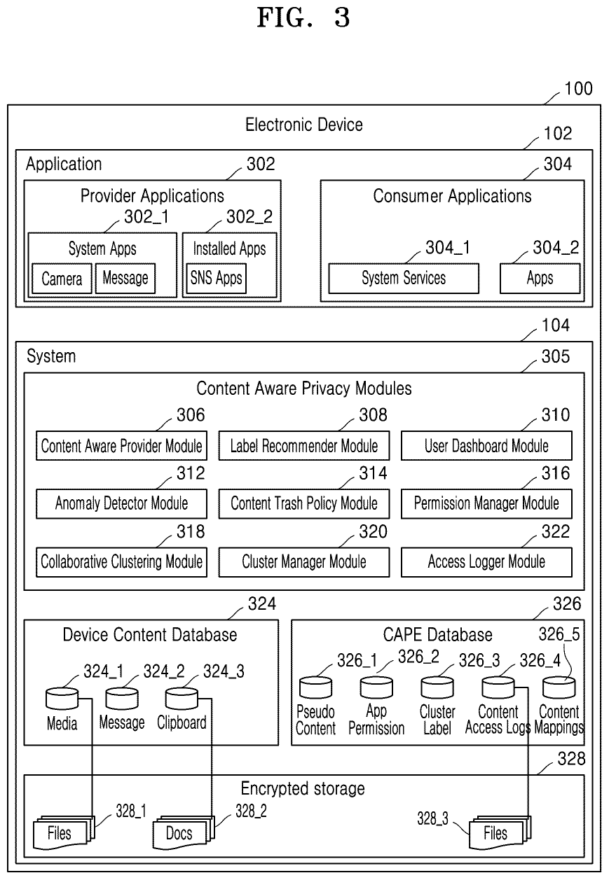

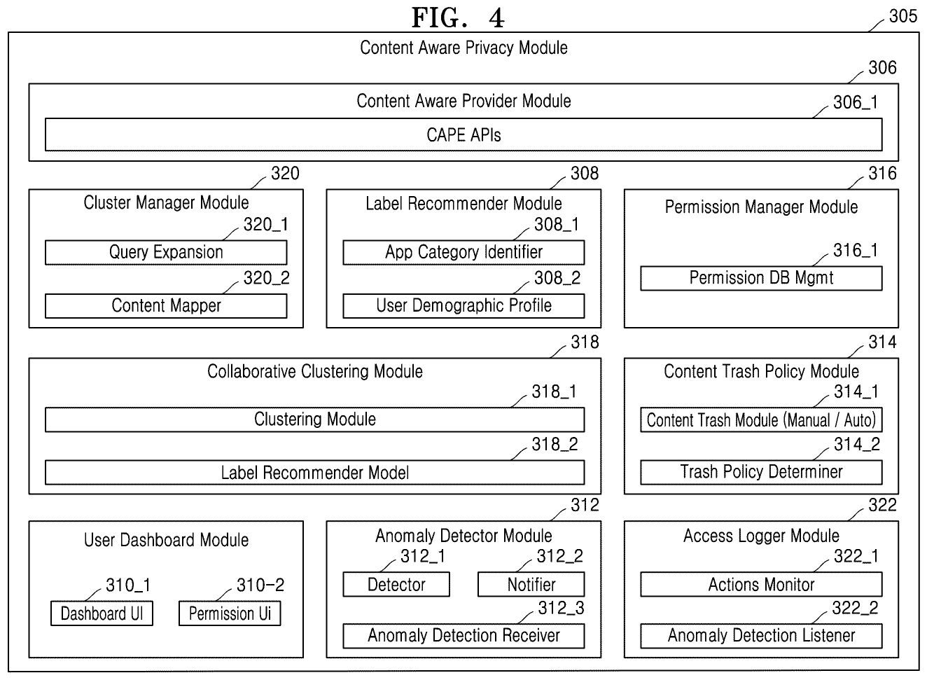

FIG. 3 illustrates a schematic architecture of the electronic device 100 including a system 104 for managing access for an application in the electronic device, according to an embodiment. FIG. 4 illustrates a block diagram of a content aware privacy module, according to an embodiment. FIG. 3 may be explained in conjunction with FIG. 4.

In one embodiment, the system 104 may receive an access request from the application 102. The application 102 may include applications 302 and 304. The applications 302 may include system applications and user-installed applications. For example, the applications 302 may include a camera application, a message application, a Social Network Service (SNS) application, and so forth.

In an embodiment, the applications 302 and 304 may be communicably coupled with the modules 206 via an interface which may be configured to receive and process the access request from the applications and share with a content aware privacy module 305.

In an embodiment, the system 104 may include the content aware privacy module 305 (interchangeably referred as “the module 305”). The module 305 may be a part of the modules 206. The module 305 may be configured to receive access request(s) from the application 102. The module 305 may further include a content aware provider module 306, a label recommender module 308, a user dashboard module 310, an anomaly detector module 312, a content trash policy module 314, a permission manager module 316, a collaborative clustering module 318, a cluster manager module 320 and an access logger module 322. Each of modules 306-322 may be communicably coupled with each other.

The content aware provider module 306 may be configured to receive the access request(s) and determine request-related data associated with the access request. In an embodiment, the request-related data may include a type of the application, a use of requested content by the application, an information associated with access provided to the application based on one or more previous requests, or an information associated with access provided to one or more applications similar to the application. The content aware provider module 306 may also be configured to generate demographic profile of the user. The content aware provider module 306 may be configured to provide label(s) corresponding to content types requested by the application via the access request based on the request-related data and demographic profile of the user. In some embodiments, the labels may correspond to semantic classes corresponding to the content. In some embodiments, the content aware provider module 306 may include different Application Programming Interfaces (APIs) to implement various functionality of the content aware provider module 306. The different APIs may establish communication interface between the application 102 and the content aware provider module 306. In some embodiments, the APIs may define rules to enable communication between the application 102 and the content aware provider module 306 using requests and responses.

In an embodiment, the label recommender module 308 may be configured to recommend semantic classes based on request related data and the demographic profile of the user. In some embodiments, the label recommender module 308 may also be configured to recommend sub-labels (for example, sub-categories and/or related classes) based on the recommended semantic classes and corresponding user selection. The label recommender module 308 may include an application category identifies configured to identify a type of the application 102. The label recommender module may store the user demographic profiles. In some embodiments, the label recommender module 308 may be configured to recommend labels corresponding to the semantic classes of the content based on the type of the application 102 and the demographic profile of the user.

The user dashboard module 310 may be configured to generate user interfaces (UIs) for the user to display labels and/or sub-labels and enable the user to view or modify user selection of the labels and sub-labels. The user dashboard module 310 may be configured to enable the user to view and manage access permission granted to the application 102. In some embodiments, the user dashboard module 310 may be configured to display and manage data access logs corresponding to the application 102, anomalies in access by the application 102 and trashing of the data. The user dashboard module 310 may be configured to generate a dashboard UI to enable the user to view and manage permission corresponding to different application installed within the electronic device 100. The user dashboard module 310 may be configured to generate permission UI enabling the user to grant/reject permission requests from the application 102.

The anomaly detector module 312 may be configured to detect anomalies in content access by the application 102. The anomaly detector module 312 may be configured to store the content access permission granted to the application 102. The anomaly detector module 312 may be configured to monitor an actual content type accessed by the application. The anomaly detector module 312 may be configured to monitor unauthorized attempt to access content. The anomaly detector module 312 may be configured to determine whether the actual content type is different than the access provided to the application 102 by the user. Upon determining that the content type, the application 102 has tried access for or has gained access for, is not authorized by the user, the anomaly detector module 312 may consider such access as anomaly or a spurious access. In some embodiments, the anomaly detector module 312 may be configured to generate an alert upon determining such anomaly or spurious access by the application 102. In an embodiment, the anomaly detector module 312 may include a detector configured to detect anomalies in content access by the application 102, an anomaly detection receiver configured to receive the detected anomalies and a notifier configured to generate an alert for the user based on the received anomalies.

The content trash policy module 314 may be configured to determine and/or store polices to delete content from the electronic device 100. The policies may define rules for deletion of content based on labels, time period, usage and so forth. In an embodiment, the content trash policy module 314 may include a content trash module configured to delete the content based on the stored policies. In some other embodiments, the content trash module may delete the content based on inputs received from the user. The content trash policy module 314 may include trash policy determiner configured to generate and update policies to effectively delete the content from the electronic device 100.

The permission manager module 316 may be configured to configured to manage permission granted to the application 102 along with user preferences. In some embodiments, the permission manager module 316 may be configured to provide backend support for the user dashboard module 310.

The collaborative clustering module 318 may be configured to train and update the label recommender module 308 based on user-related data corresponding to different users. In an embodiment, the different users may share a similar demographic profile. The collaborative clustering module 318 may be configured to implement distributed learning technique to enable the label recommender module 308 to learn and update labels corresponding to different content types. In an embodiment, the collaborative clustering module 318 may include clustering model configured to generate cluster of content based on corresponding labels. The collaborative clustering module 318 may include label recommender model configured to train and update the label recommender module 308 based on user-related data corresponding to different users.

In an embodiment, the collaborative clustering module 318 may also include a Machine Learning (ML) framework includes Federated Learning (FL) APIs and learning APIS. The collaborative clustering module 318 may be configured train and update the label recommender module 308 using the ML framework. In some embodiment, the collaborative clustering module 318 may be coupled with a server (now shown) to implement the training process. The server may be located remotely to the electronic device. The server may include a round management unit configured to execute training rounds for the collaborative clustering module 318. The server may include model store configured to store various model used for training the collaborative clustering module 318. The server may include client manger configured to manage various electronic devices connected to the server. The server may also include an aggregator configured to aggregates model weights received from various electronic devices. The server may further include a policy manager configured to manage policies for training and aggregation. The policies may include information such as, but not limited to, selection criteria of model, selection timeout, aggregation strategy and so forth. The server may include training plan store configured to store training paths with corresponding policy information. In an embodiment, the server may receive various training models from the different electronic devices connected with the server. The server may aggregates the models and shared an updated model with the connected electronic devices.

The cluster manager module 320 may be configured to manager cluster of different content types and corresponding labels. The cluster manager module 320 may be configured to maintain a database for content and label mapping. The cluster manager module 320 may create a relationship between content and corresponding label by generating and mapping content IDs with corresponding content labels. In some embodiments, the cluster manager module 320 may be configured to perform query expansion to determine various parameters in access request received from the application 102. The cluster manager module 320 may include a content mapper configured to map content with corresponding labels.

The access logger module 322 may be configured to log all the access requests or accesses performed by the application 102. The access logger module 322 may be configured to provide data to the anomaly detector module 312 to enable the module 312 detect anomalies. In an embodiment, the access logger module 322 may include action monitor configured to monitor accesses by the application 102. The access logger module 322 may include an anomaly detection listener configured to receive anomalies detected by the anomaly detector module 312.

The system 104 may also include a device content database 324. The device content database 324 may be stored with the memory 210. The device content database 324 may be configured to store media content corresponding to various content types in the electronic device 100. The content types may include, but not limited to, media content, messages, clipboard and so forth.

The system 104 may also include a content aware privacy engine (CAPE) database 326 (interchangeably referred as “the database 326”). The database 326 may be configured to store content/information such as, but not limited to, pseudo content, application permission, cluster labels, content access logs and content mapping. The system 104 may include an encrypted storage 328 configured to store files corresponding to different content types.

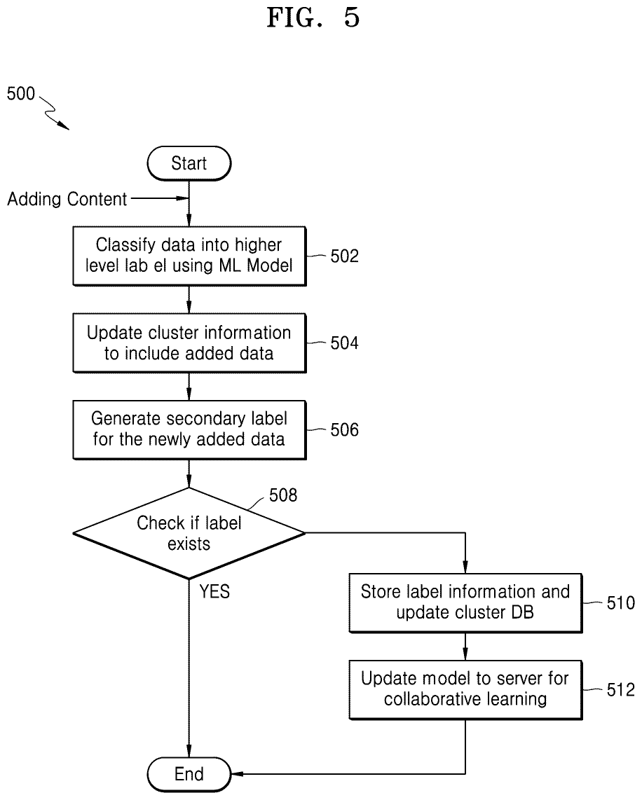

FIG. 5 illustrates a flow chart of a method 500 of adding content, according to an embodiment. The method 500 corresponds to adding new content to a database of the electronic device 100. In some embodiments, the new content/data may be received from the application 102.

At operation 502, the method 500 includes classifying new data into higher level labels. In an embodiment, the system 104 may be configured to implement machine learning technique to classify the data into higher level labels. At operation 504, the method 500 includes updating the cluster information to include the added data. Next at operation 506, the method 500 includes generating secondary labels for the newly added data. The method 500 includes utilizing clustering machine learning models to generate secondary level of semantic categories/labels for the newly added data. For example, if the added data corresponds to financial data, a higher-level label may be “banking” and the secondary level of semantic categories may include “accounts”, “credits”, and “insurance”. At operation 508, the method 500 includes determining whether the generated secondary label exists or not. Upon determining that the generated secondary label does not exist, the method 500 may move to operation 510. At operation 510, the method 500 includes storing the label information corresponding to the secondary label and update the cluster database. At operation 512, the method 500 includes updating the server to implement collaborative learning. In case a new label or sub-label is determined, the method include 500 updating the server with the newly determined labels or sub-labels.

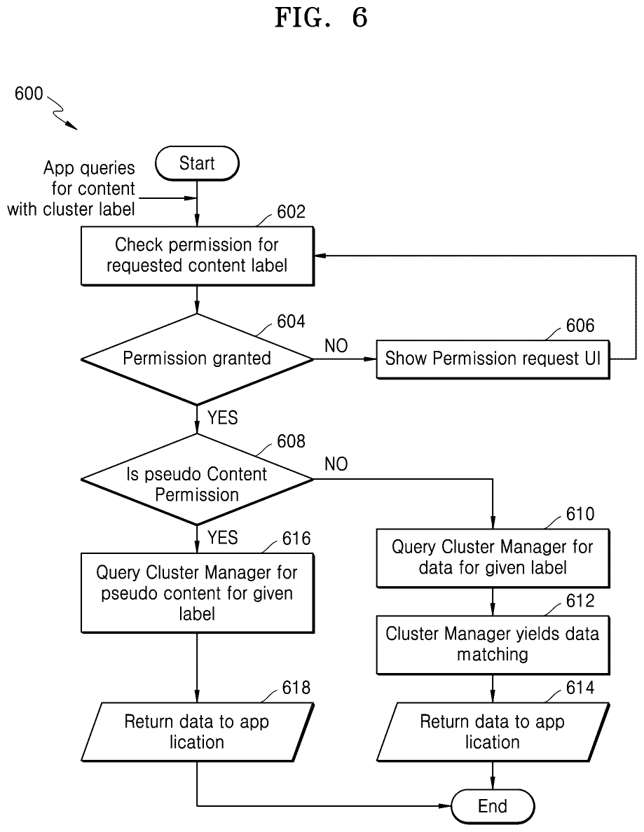

FIG. 6 illustrates a flow chart of a method 600 of querying content by an application, according to an embodiment. The method 600 may initialize when the application request for content corresponding a content label.

At operation 602, the method 600 includes check for permission corresponding the requested content label. At operation 604, the method 600 includes determining whether the application 102 is granted with permission to access the content with the requested label or not. Upon determining that the permission corresponding to the requested label has not been granted to the application 102, the method 600 moves to operation 606 and displays a user interface (UI) to the user indicating that the application 102 has requested for permission to access data corresponding to the requested content label. The UI may also enable the user select whether the user wishes to allow the application 102 access to the requested content label or not. Upon determining that the permission corresponding to the requested has already been granted to the application 102, the method 600 moves to operation 608 and determines whether the granted permission corresponds to pseudo content or actual content. Upon determining that the granted permission corresponds to pseudo content, the method 600 moves to operation 616. At operation 616, the method 600 includes querying the cluster manager for pseudo content for the request content label. At operation 618, the method 600 includes returning the data to the application.

Further at operation 608, upon determining the granted permission is not for pseudo content but for actual content, the method 600 moves to operation 610. At operation 610, the method 600 includes querying the cluster manager for data corresponding to the requested content label. At operation 612, the cluster manager module yield data matching with the requested content label. At operation 614, the method 600 includes returning the data to the application 102.

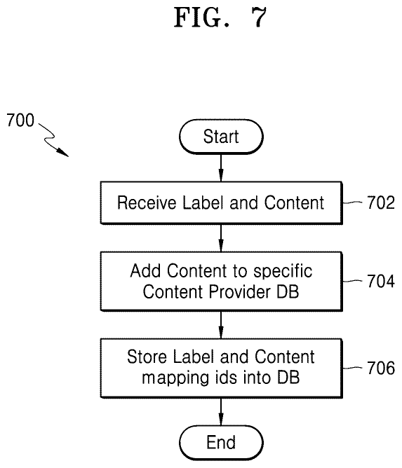

FIG. 7 illustrates a flow chart of a method 700 of adding content, according to another embodiment.

At operation 702, the method 700 includes receiving label and content. In an embodiment, the content may be received from the application 102 and the corresponding label may be received from the content aware provider module 306. At operation 704, the method 700 includes adding the received content to the device content database 324 based on the received label. At operation 706, the method 700 includes storing the label and content mapping IDs into the cluster database.

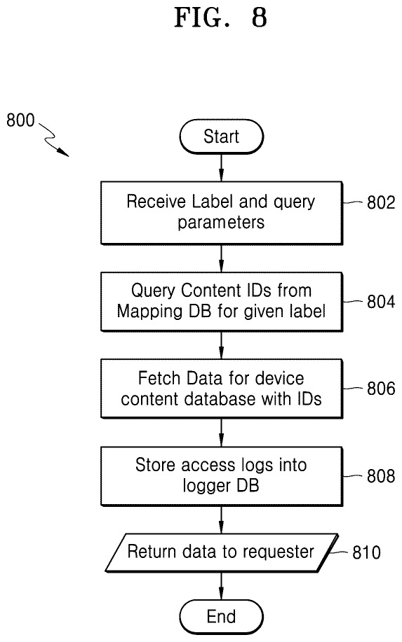

FIG. 8 illustrates a flow chart of a method 800 of querying content by an application, according to another embodiment.

At operation 802, the method 800 includes receiving label and query parameters. In an embodiment, the query parameters may correspond to parameters associated with a query for content received from the application 102. The cluster manager module 320 may add the label to the query based on the query parameters. At operation 804, the method 800 includes querying the database for content IDs corresponding the requested label. At operation 806, the method 800 includes fetching data from the device content database 324 with the fetched content IDs. At operation 808, the method 800 includes storing access log into logger database. At operation 810, the method 800 includes returning the data to the application 102.

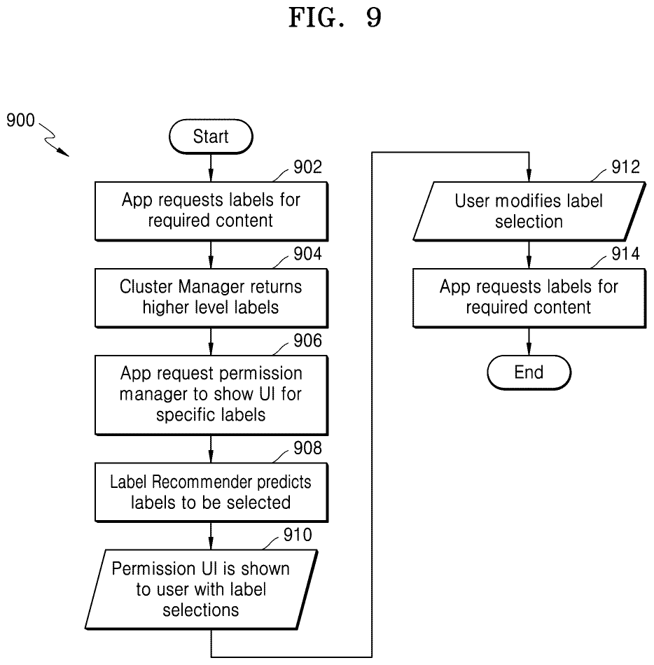

FIG. 9 illustrates a flow chart of a method 900 for permission management of an application, according to an embodiment.

At operation 902, the application 102 requests labels corresponding to content from the system 104. At operation 904, the cluster manager module 320 of the system 104 return higher level labels corresponding to the content. At operation 906, the application 102 requests the permission manager module 316 to display UI for the labels provided by the cluster manager module 320. At operation 908, the label recommender module 308 predicts labels to be selected. In an embodiment, the label recommender module 308 may predicts the labels to be selected by the user based on a type of application 102 and user's demography profile. At operation 910, the permission manager module 316 displays the user with the labels selected by the label recommender module 308. At operation 912, the user selects labels to modify the label selection. In an embodiment, the user may continue with labels selected by the label recommender module 308. In another embodiment, the user may modify the label selection. At operation 914, the system 104 saves cluster access information for the application 102 into the application permission database based on the user selection for further access requests. In some alternative embodiments, the application 102 may directly requests the permission manager module 316 to display user with labels to get access to request content.

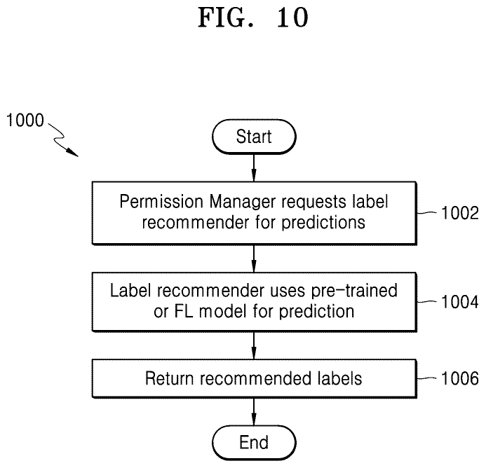

FIG. 10 illustrates a flow chart of a method 1000 of label prediction, according to an embodiment. At operation 1002, the permission manager module 316 requests the label recommender module 308 for prediction of labels corresponding to content access request received from the application 102. At operation 1004, the label recommender module 308 uses pre-trained models to predict labels corresponding to the requested content. At operation 1006, the label recommender module 308 returns the predicted labels.

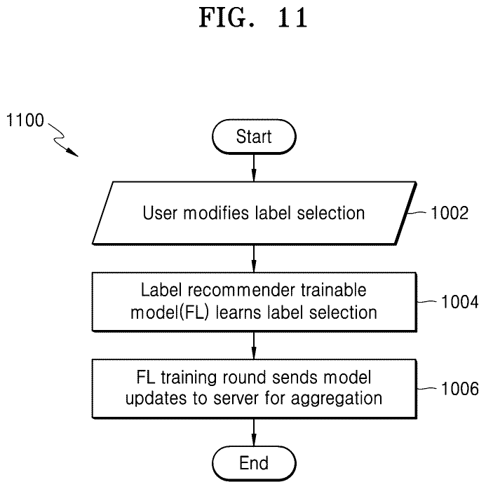

FIG. 11 illustrates a flow chart of a method 1100 of label training, according to an embodiment.

At operation 1102, the user modifies label selection suggested by the label recommender module 308. At operation 1104, the label recommender module 308 learns the label selection by the user and updates a distributed model used to predict labels. At operation 1106, FL training round sends model updates to the server for aggregation. Model updates with corresponding model weights may be transmitted to the server for aggregation.

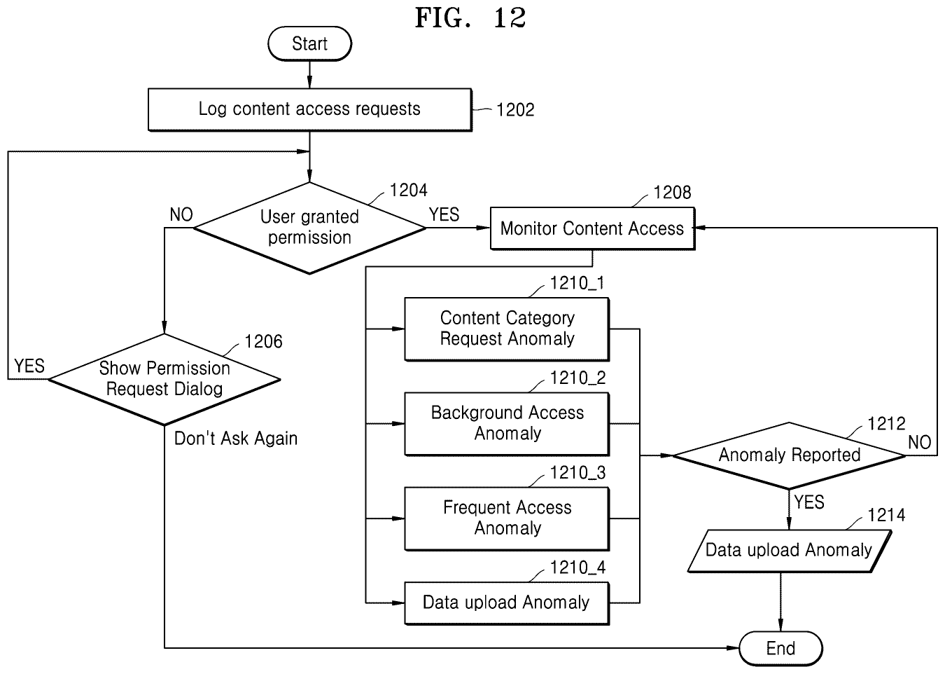

FIG. 12 illustrates a flow chart of a method 1200 of anomaly detection, according to an embodiment.

In an embodiment, the method 1200 initiate with a content access request received from the application 102. At operation 1202, the method 1200 includes logging content access request(s) received from the application 102. At operation 1204, the method 1200 includes determining whether the user has granted permission to the application 102 or not. Upon determining that the application 102 has not been granted permission to access the content, the method 1200 moves to operation 1206. At operation 1206, the method 1200 includes display permission request UI to the user. Upon determining that the application 102 has been granted permission to access the content, the method 1200 moves to operation 1208. At operation 1208, the method 1200 includes monitoring content access by the application 102. Based on the content accessed by the application, the method 1200 includes determining anomalies in content access, as shown by the operation 1210. The different kind of anomalies which may be detected by the system 104 may include, but not limited to, content category request anomaly, background access anomaly, frequent access anomaly, data upload anomaly and so forth. The content category request anomaly may be detected when the application 102 fetches and stores data from non-permitted label/class. The background access anomaly may be detected when the application 102 fetches and stored data during the inactive state or when the application is in background. The frequent access anomaly may be detected when the application 102 makes abnormal number of requests to access the data. The data upload anomaly may be detected when the application 102 tries to upload data without user's consent and/or knowledge. At operation 1212, the method 1200 includes determining whether the anomaly has been reported or not. In case, no anomaly has been detected, the method 1200 moves back to operation 1208. In case an anomaly is detected, the method 1200 moves to operation 1214. At operation 1214, the method 1200 includes alerting the user based on reported anomaly. In some embodiments, the anomaly situations may be flagged off using FL model if another user with similar demography profile ratifies the situation.

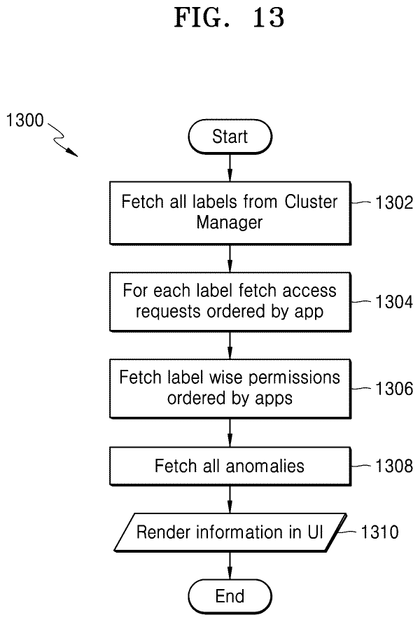

FIG. 13 illustrates a flow chart of a method 1300 for rendering a user interface (UI), according to an embodiment. At operation 1302, the method 1300 includes fetching all the labels from the cluster manager module. At operation 1304, the method 1300 includes fetching access requests by the application 102 for each label. At operation 3106, the method 1300 includes fetching label wise permission ordered by the application 102. At operation 1308, the method 1300 includes fetching all anomalies detected by the system 104. At operation 1310, the method 1300 includes rendering information in UI.

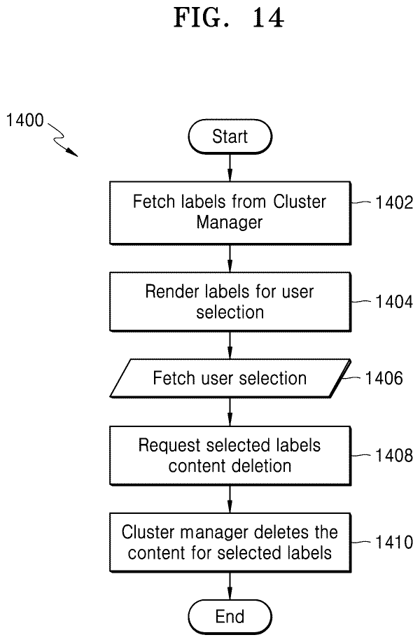

FIG. 14 illustrates a flow chart of a method 1400 for cleaning content, according to an embodiment.

At operation 1402, the method 1400 includes fetching labels from the cluster manager module. At operation 1404, the method 1400 includes rendering labels for user selection. At operation 1406, the method 1400 includes fetching user selection. At operation 1408, the method includes requesting selected labels content deletion. At operation 1410, the cluster manager deletes the content for selected labels.

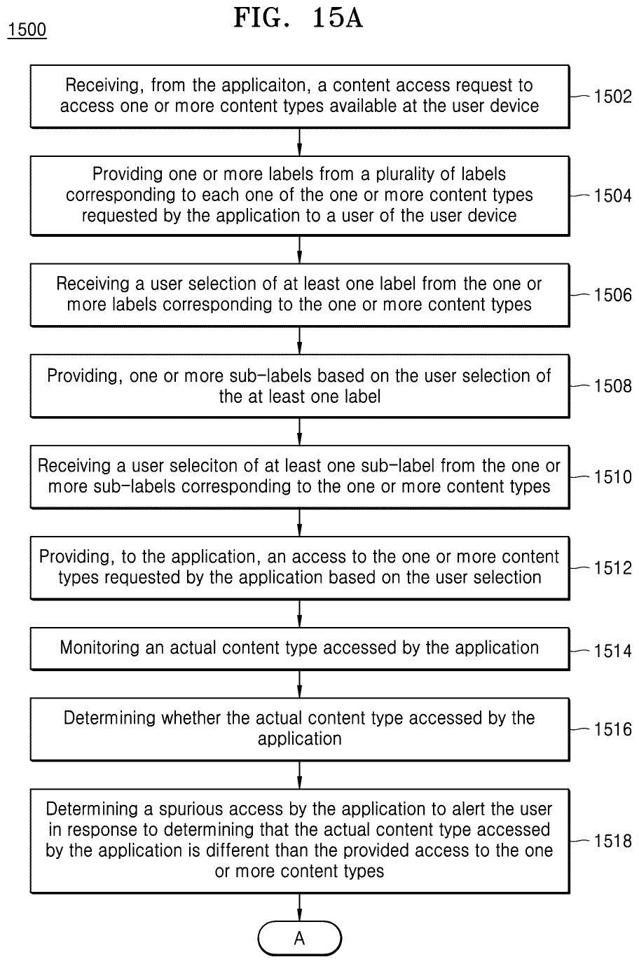

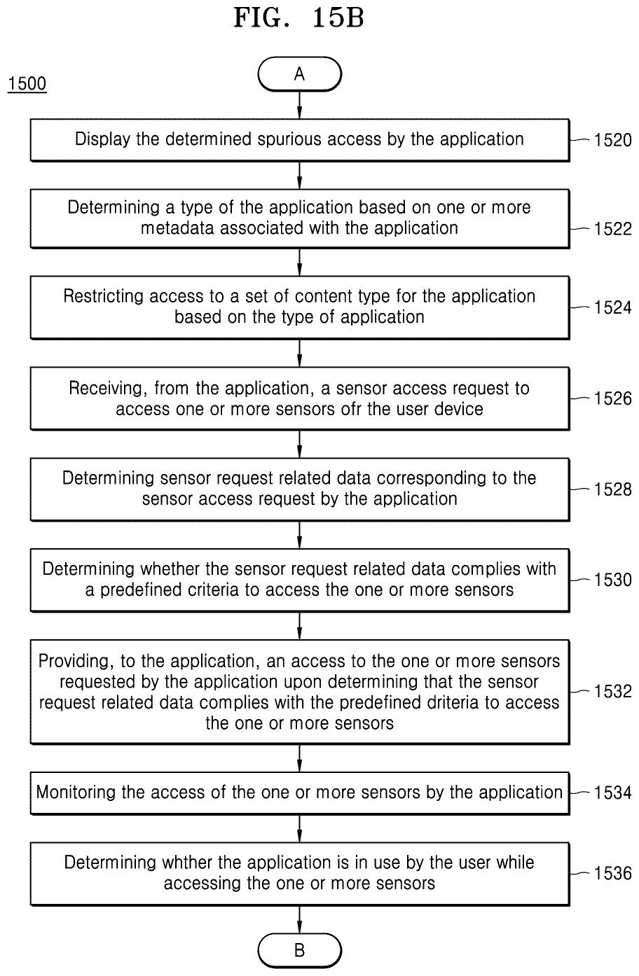

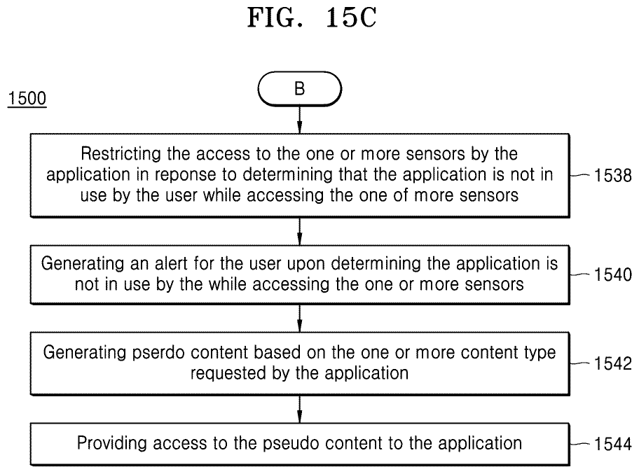

FIGS. 15A-15C illustrate a flow chart of a method 1500 for managing access of content for an application in an electronic device, according to an embodiment.

At operation 1502, the method 1500 includes receiving a content access request from the application 102. The content access request may correspond to a request to access one or more content types available at the electronic device 100. At operation 1504, the method 1500 includes providing one or more labels from a plurality of labels corresponding to each one of the one or more content types requested by the application to a user of the electronic device 100. At operation 1506, the method 1500 includes receiving a user selection of at least one label from the one or more labels corresponding to the one or more content types. Next at operation 1508, the method 1500 includes providing, one or more sub-labels based on the user selection of the at least one label. At operation 1510, the method 1500 includes receiving a user selection of at least one sub-label from the one or more sub-labels corresponding to the one or more content types. At operation 1512, the method 1500 includes providing, to the application, an access to the one or more content types requested by the application based on the user selection.

Further at operation 1514, the method 1500 includes monitoring an actual content type accessed by the application. At operation 1516, the method 1500 includes determining whether the actual content type is different from the provided access to the one or more content types. Next at operation 1518, the method 1500 includes determining a spurious access by the application to alert the user in response to determining that the actual content type accessed by the application is different than the provided access to the one or more content types. At operation 1520, the method 1500 includes displaying the determined spurious access by the application 102.

At operation 1522, the method 1500 includes determining a type of the application based on one or more metadata associated with the application. Next at operation 1524, the method 1500 includes restricting access to a set of content type for the application based on the type of application.

At operation 1526, the method 1500 includes receiving, from the application, a sensor access request to access one or more sensors of the electronic device. At operation 1528, the method 1500 includes determining sensor request related data corresponding to the sensor access request by the application. At operation 1530, the method 1500 includes determining whether the sensor request related data complies with a predefined criteria to access the one or more sensors. At operation 1532, the method 1500 includes providing, to the application, an access to the one or more sensors requested by the application upon determining that the sensor request related data complies with the predefined criteria to access the one or more sensors.

At operation 1534, the method 1500 includes monitoring the access of the one or more sensors by the application. At operation 1536, the method 1500 includes determining whether the application is in use by the user while accessing the one or more sensors. At operation 1538, the method 1500 includes restricting the access to the one or more sensors by the application in response to determining that the application is not in use by the user while accessing the one or more sensors.

At operation 1540, the method 1500 includes generating an alert for the user upon determining the application is not in use by the user while accessing the one or more sensors. At operation 1542, the method 1500 includes generating pseudo content based on the one or more content type requested by the application. At operation 1544, the method 1500 includes providing access to the pseudo content to the application.

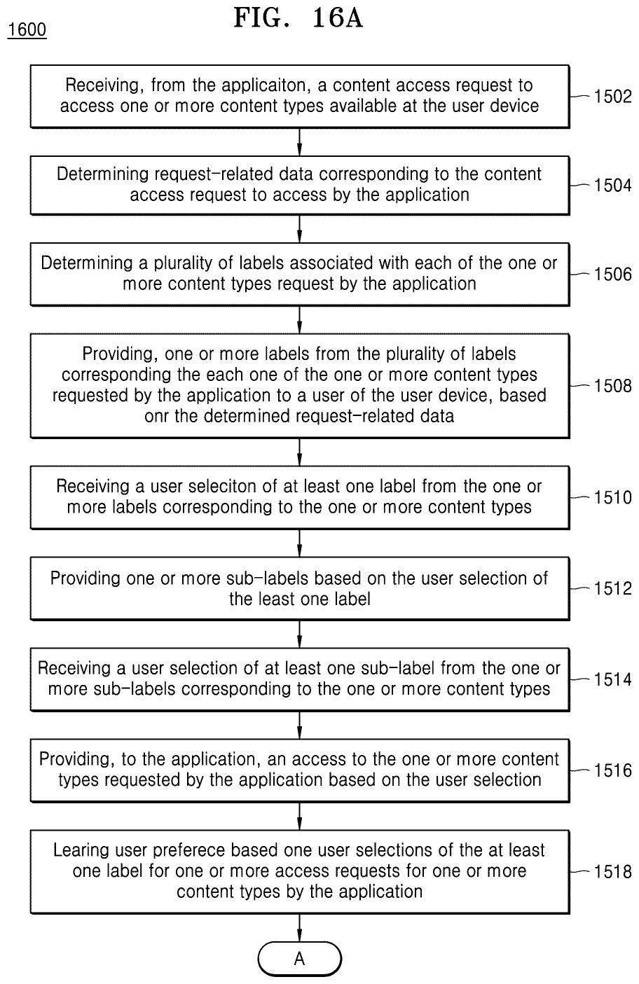

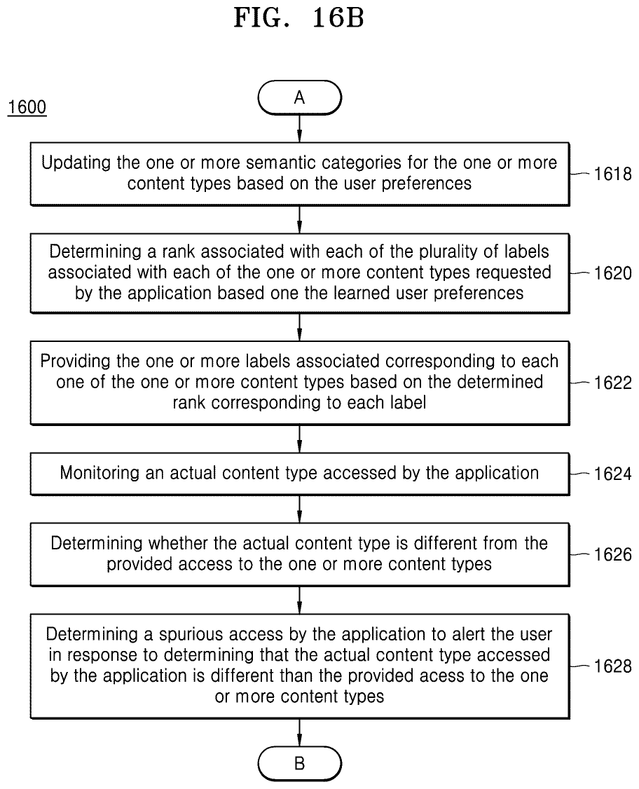

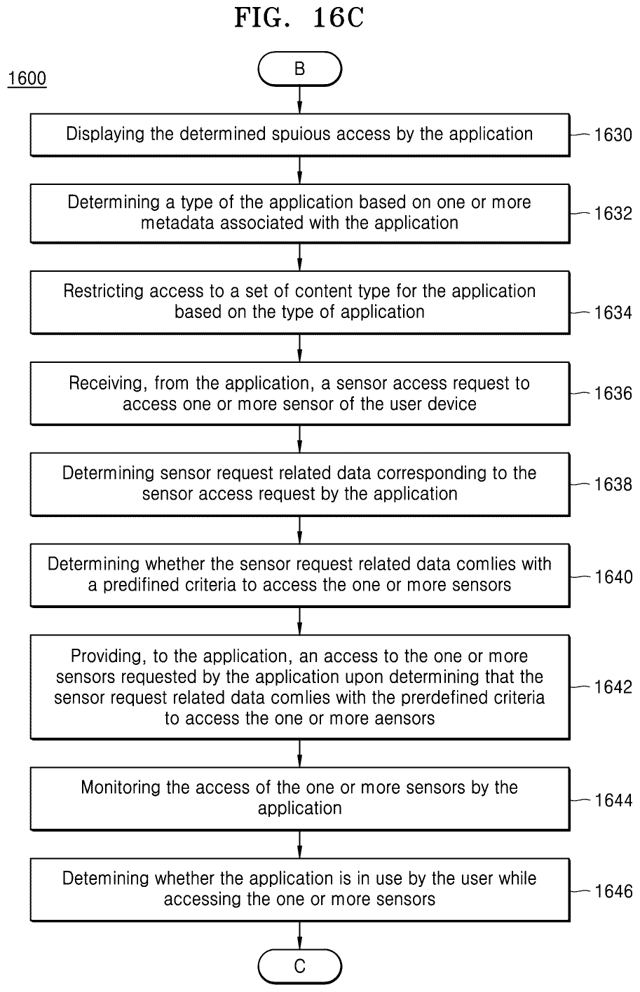

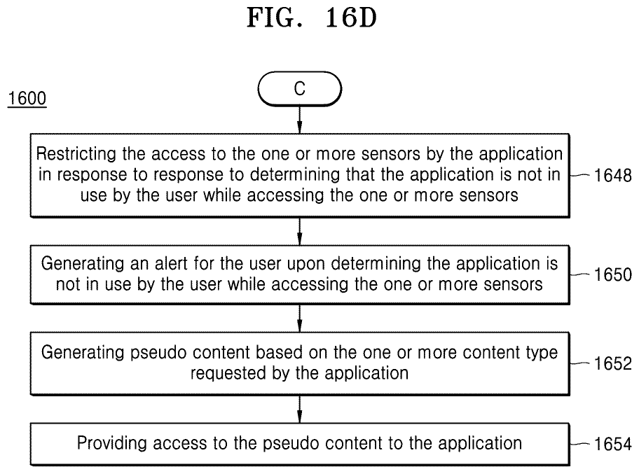

FIGS. 16A-16D illustrate a flow chart of a method 1600 for managing access of content for an application in an electronic device, according to another embodiment.

At operation 1602, the method 1600 includes receiving, from the application, a content access request to access one or more content types available at the electronic device. At operation 1604, the method 1600 includes determining request-related data corresponding to the content access request to access by the application. At operation 1606, the method 1600 includes determining a plurality of labels associated with each of the one or more content types requested by the application. At operation 1608, the method 1600 includes providing one or more labels from the plurality of labels corresponding to each one of the one or more content types requested by the application to a user of the electronic device, based on the determined request-related data. At operation 1610, the method 1600 includes receiving a user selection of at least one label from the one or more labels corresponding to the one or more content types. At operation 1611, the method 1600 includes providing, one or more sub-labels based on the user selection of the at least one label. At operation 1612, the method 1600 includes receiving a user selection of at least one sub-label from the one or more sub-labels corresponding to the one or more content types. At operation 1614, the method 1600 includes providing, to the application, an access to the one or more content types requested by the application based on the user selection.

At operation 1616, the method 1600 includes learning user preferences based on user selections of the at least one label for one or more access requests for one or more content types by the application. At operation 1618, the method 1600 includes updating the one or more semantic categories for the one or more content types based on the user preferences.

At operation 1620, the method 1600 includes determining a rank associated with each of the plurality of labels associated with each of the one or more content types requested by the application based on the learned user preferences. At operation 1622, the method 1600 includes providing the one or more labels associated corresponding to each one of the one or more content types based on the determined rank corresponding to each label for further recommendations.

For additional implementation details of operations 1624-1654, reference may be made to the descriptions of operations 1514-1544.

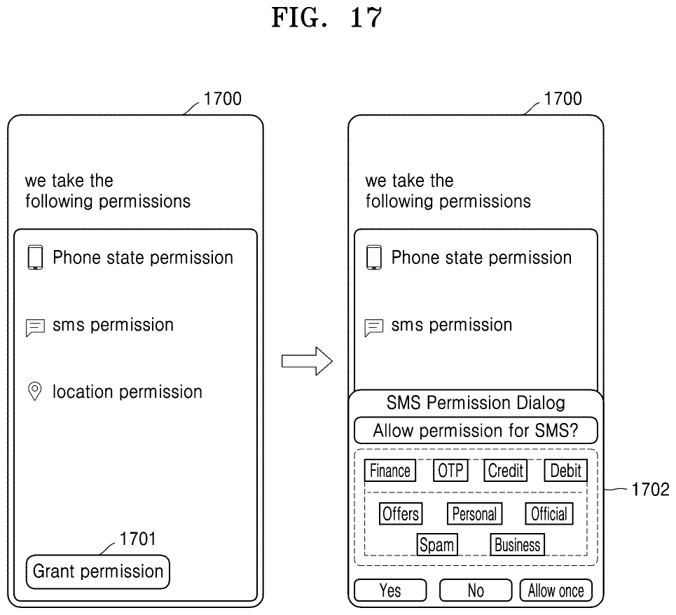

FIG. 17 illustrates generation of labels for a content access request by a messaging application, according to an embodiment.

In the illustrated embodiment, the messaging application 1700 requests access to messages stored in the electronic device 100. The messaging application 1700 requests to select a grant permission button 1701. The system 104 may generate labels corresponding to the grant permission button 1701 and display to the user via a user interface 1702. In an embodiment, the labels include finance, OTP, credit and debit. The system 104 may also generate some sub-labels such as, offers, personal, official, spam and business. The UI 1702 may be configured to receive user selection of one or more labels and/or sub-label to allow the messaging application to access the user selected messages. The UI 1702 may also enable the user to reject the request or allow the request for one time.

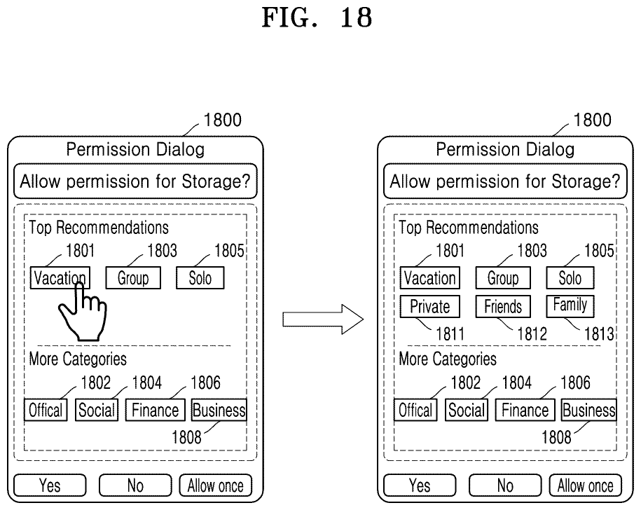

FIG. 18 illustrates recommendation of labels for media access request by an application, according to an embodiment.

In the illustrated embodiment, the application requests access for storage for access image file. The system 104 may display labels 1800 based on received request. For example, the system 104 may display recommendations such as “vacation” 1801, “group” 1803, and “solo” 1805. The system 104 may display additional recommendations such as “official” 1802, “social” 1804, “finance” 1806 and “business” 1808. Once a user selects a label, for example “vacation” 1801, the system 104 may display sub-labels corresponding to the user selected label. For example, the system 104 display “private” 1811, “friends” 1812 and “Family” 1813, as sub-labels corresponding the user selected label “vacation” 1801.

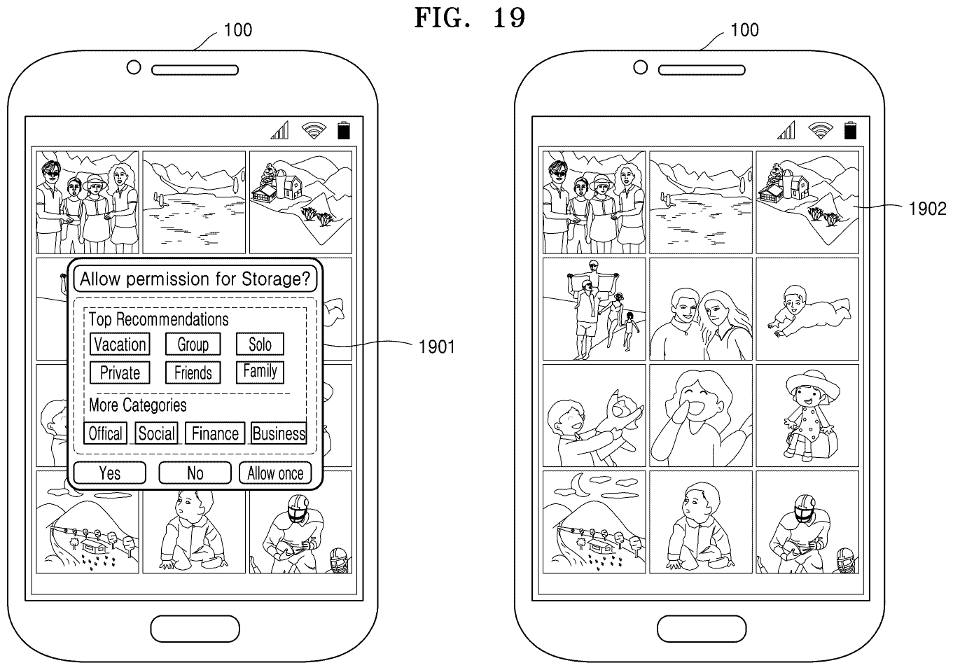

FIG. 19 illustrates recommendation of labels for media access request by an application, according to another embodiment.

In the illustrated embodiment, the application 1900 requests access for storage to access image files stored in the electronic device 100. The system 104 may suggest labels 1901 corresponding to image files. The system 104 may also allow the user to select image files 1902 to which the user wishes to grant access to the application 102.

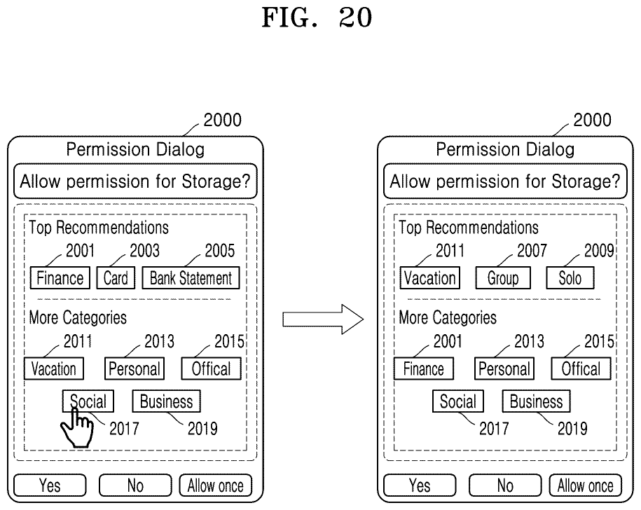

FIG. 20 illustrates learning recommendation, according to an embodiment.

For example, based on a storage access request from an application, the system 104 may recommend labels 2000 such as finance 2001, card 2003 and bank statement 2005. The system 104 may also recommend some additional labels such as, vacation 2011, personal 2013, official 2015, social 2017 and business 2019. When a select from additional labels such as “vacation” 2011, the system 104 may learn user preference based on selected label and recommend labels for future request based on user preference.

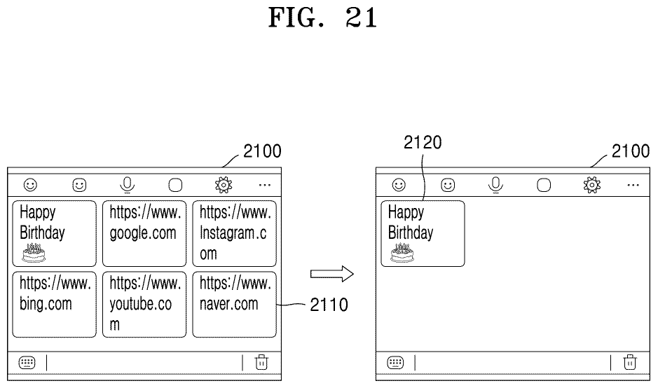

FIG. 21 illustrates a comparison of clipboard content access according to a technique and an embodiment.

According to the technique, all the information 2110 store in clipboard 2100 may be accessed by any application installed with the electronic device 100. For example, all clipboard contents are available (visible) to all apps. According to an embodiment of present disclosure, the system 104 may enable a user to allow access to selective information 2120 from the clipboard 2100, as shown in FIG. 21. For example, dynamically selected contents are shows to apps.

In an embodiment, a method (1500) for managing access of content for an application in an electronic device is disclosed. The method (1500) includes receiving (1502), from the application, a content access request to access one or more content types available at the electronic device. The method (1500) includes providing (1504) one or more labels from a plurality of labels corresponding to each one of the one or more content types requested by the application to a user of the electronic device. The method (1500) includes receiving (1506) a user selection of at least one label from the one or more labels corresponding to the one or more content types. The method (1500) includes providing (1512), to the application, an access to the one or more content types requested by the application based on the user selection.

In an embodiment, the method (1500) includes providing (1508), one or more sub-labels based on the user selection of the at least one label. The method (1500) includes receiving (1510) a user selection of at least one sub-label from the one or more sub-labels corresponding to the one or more content types. The method (1500) includes providing (1512), to the application, the access to the one or more content types requested by the application based on the user selection of the at least one sub-label.

In an embodiment, the one or more content types comprises at least one of images, videos, text messages, electronic device information, and sensors-related data.

In an embodiment, the method (1500) includes monitoring (1514) an actual content type accessed by the application. The method (1500) includes determining (1516) whether the actual content type is different from the provided access to the one or more content types. The method (1500) includes determining (1518) a spurious access by the application to alert the user in response to determining that the actual content type accessed by the application is different than the provided access to the one or more content types. The method (1500) includes displaying (1520) the determined spurious access by the application.

In an embodiment, the method (1500) includes determining (1522) a type of the application based on one or more metadata associated with the application. The method (1500) includes restricting (1524) access to a set of content type for the application based on the type of application.

In an embodiment, the method (1500) includes receiving (1526), from the application, a sensor access request to access one or more sensors of the electronic device (100). The method (1500) includes determining (1528) sensor request related data corresponding to the sensor access request by the application. The method (1500) includes determining (1530) whether the sensor request related data complies with a predefined criteria to access the one or more sensors. The method (1500) includes providing (1532), to the application, an access to the one or more sensors requested by the application upon determining that the sensor request related data complies with the predefined criteria to access the one or more sensors.

In an embodiment, the method (1500) includes monitoring (1534) the access of the one or more sensors by the application. The method (1500) includes determining (1536) whether the application is in use by the user while accessing the one or more sensors. The method (1500) includes restricting (1538) the access to the one or more sensors by the application in response to determining that the application is not in use by the user while accessing the one or more sensors.

In an embodiment, the method (1500) includes generating (1540) an alert for the user upon determining that the application is not in use by the user while accessing the one or more sensors.

In an embodiment, the method (1500) includes generating (1542) pseudo content based on the one or more content type requested by the application. The method (1500) includes providing (1544) access to the pseudo content to the application.

In an embodiment, a method (1600) for managing access of content for an application in an electronic device (100) is disclosed. The method (1600) includes receiving (1602), from the application, a content access request to access one or more content types available at the electronic device (100). The method (1600) includes determining (1604) request-related data corresponding to the content access request by the application. The method (1600) includes determining (1606) a plurality of labels associated with each of the one or more content types requested by the application, wherein the plurality of the labels corresponds to a plurality of semantic categories associated with the one or more content types. The method (1600) includes providing (1608) one or more labels from the plurality of labels corresponding to each one of the one or more content types requested by the application to a user of the electronic device, based on the determined request-related data. The method (1600) includes receiving (1610) a user selection of at least one label from the one or more labels corresponding to the one or more content types. The method (1600) includes providing (1614), to the application, an access to the one or more content types requested by the application based on the user selection.

In an embodiment, the request-related data comprises at least one of a type of the application, a use of requested content by the application, an information associated with access provided to the application based on one or more previous requests, or an information associated with access provided to one or more applications similar to the application.

In an embodiment, the plurality of semantic categories associated with the one or more content types is based on a demographic profile of the user.

In an embodiment, the demographic profile of the user is based on at least one of a location, an age, a sex, race, and user-interests.

In an embodiment, the method (1600) includes providing (1611), one or more sub-labels based on the user selection of the at least one label. The method (1600) includes receiving (1612) a user selection of at least one sub-label from the one or more sub-labels corresponding to the one or more content types. The method (1600) includes providing (1614), to the application, the access to the one or more content types requested by the application based on the user selection of the at least one sub-label.

In an embodiment, the one or more content types comprises at least one of images, videos, text messages, electronic device information, and sensors-related data.

In an embodiment, the method (1600) includes learning (1616) user preferences based on user selections of the at least one label for one or more access requests for one or more content types by the application. The method (1600) includes updating (1618) the one or more semantic categories for the one or more content types based on the user preferences.

In an embodiment, the method (1600) includes determining (1620) a rank associated with each of the plurality of labels associated with each of the one or more content types requested by the application based on the learned user preferences. The method (1600) includes providing (1622) the one or more labels associated corresponding to each one of the one or more content types based on the determined rank corresponding to each label.

In an embodiment, the method (1600) includes monitoring (1624) an actual content type accessed by the application. The method (1600) includes determining (1626) whether the actual content type is different from the provided access to the one or more content types. The method (1600) includes determining (1628) a spurious access by the application to alert the user in response to determining that the actual content type accessed by the application is different than the provided access to the one or more content types. The method (1600) includes displaying (1630) the determined spurious access by the application.

In an embodiment, the method (1600) includes determining (1632) a type of the application based on one or more metadata associated with the application. The method (1600) includes restricting (1634) access to a set of content type for the application based on the type of application.

In an embodiment, the method (1600) includes receiving (1636), from the application, a sensor access request to access one or more sensors of the electronic device. The method (1600) includes determining (1638) sensor request related data corresponding to the sensor access request by the application. The method (1600) includes determining (1640) whether the sensor request related data complies with a predefined criteria to access the one or more sensors. The method (1600) includes providing (1642), to the application, an access to the one or more sensors requested by the application upon determining that the sensor request related data complies with the predefined criteria to access the one or more sensors.

In an embodiment, the method (1600) includes monitoring (1644) the access of the one or more sensors by the application. The method (1600) includes determining (1646) whether the application is in use by the user while accessing the one or more sensors. The method (1600) includes restricting (1648) the access to the one or more sensors by the application in response to determining that the application is not in use by the user while accessing the one or more sensors.

In an embodiment, the method (1600) includes generating (1650) an alert for the user upon determining that the application is not in use by the user while accessing the one or more sensors.

In an embodiment, the method (1600) includes generating (1652) pseudo content based on the one or more content type requested by the application. The method (1600) includes providing (1654) access to the pseudo content to the application.

In an embodiment, an electronic device (100) for managing access to an application is disclosed. The electronic device (100) includes a memory (210) and at least one processor (202) communicably coupled to the memory. The at least one processor (202) is configured to receive, from the application, a content access request to access one or more content types available at the electronic device (100). The at least one processor (202) is configured to provide one or more labels from a plurality of labels corresponding to each one of the one or more content types requested by the application to a user of the electronic device (100). The at least one processor (202) is configured to receive a user selection of at least one label from the one or more labels corresponding to the one or more content types. The at least one processor (202) is configured to provide, to the application, an access to the one or more content types requested by the application based on the user selection.

In an embodiment, the at least one processor (202) is configured to provide, one or more sub-labels based on the user selection of the at least one label. The at least one processor (202) is configured to receive a user selection of at least one sub-label from the one or more sub-labels corresponding to the one or more content types. The at least one processor (202) is configured to provide, to the application, the access to the one or more content types requested by the application based on the user selection of the at least one sub-label.

In an embodiment, the one or more content types comprises at least one of images, videos, text messages, electronic device information, and sensors-related data.

In an embodiment, the at least one processor (202) is configured to monitor an actual content type accessed by the application. The at least one processor (202) is configured to determine whether the actual content type is different from the provided access to the one or more content types. The at least one processor (202) is configured to determine a spurious access by the application to alert the user in response to determining that the actual content type accessed by the application is different than the provided access to the one or more content types. The at least one processor (202) is configured to display the determined spurious access by the application.

In an embodiment, the at least one processor (202) is configured to determine a type of the application based on one or more metadata associated with the application. The at least one processor (202) is configured to restrict access to a set of content type for the application based on the type of application.

In an embodiment, the at least one processor (202) is configured to receive, from the application, a sensor access request to access one or more sensors of the electronic device (100). The at least one processor (202) is configured to determine sensor request related data corresponding to the sensor access request by the application. The at least one processor (202) is configured to determine whether the sensor request related data complies with a predefined criteria to access the one or more sensors. The at least one processor (202) is configured to provide, to the application, an access to the one or more sensors requested by the application upon determining that the sensor request related data complies with the predefined criteria to access the one or more sensors.

In an embodiment, the at least one processor (202) is configured to monitor the access of the one or more sensors by the application. The at least one processor (202) is configured to determine whether the application is in use by the user while accessing the one or more sensors. The at least one processor (202) is configured to restrict the access to the one or more sensors by the application in response to determining that the application is not in use by the user while accessing the one or more sensors.

In an embodiment, the at least one processor (202) is configured to generate an alert for the user upon determining that the application is not in use by the user while accessing the one or more sensors.

In an embodiment, the at least one processor (202) is configured to generate pseudo content based on the one or more content type requested by the application. The at least one processor (202) is configured to provide access to the pseudo content to the application.

In an embodiment, an electronic device (100) for managing access of content for an application in the electronic device (100) is disclosed. The electronic device (100) includes a memory (210) and at least one processor (202) communicably coupled to the memory (210). The at least one processor (202) is configured to receive, from the application, a content access request to access one or more content types available at the electronic device (100). The at least one processor (202) is configured to determine request-related data corresponding to the content access request. The at least one processor (202) is configured to determine a plurality of labels associated with each of the one or more content types requested by the application, wherein the plurality of the labels corresponds to a plurality of semantic categories associated with the one or more content types. The at least one processor (202) is configured to provide one or more labels from the plurality of labels corresponding to each one of the one or more content types requested by the application to a user of the electronic device, based on the determined request-related data. The at least one processor (202) is configured to receive a user selection of at least one label from the one or more labels corresponding to the one or more content types. The at least one processor (202) is configured to provide, to the application, an access to the one or more content types requested by the application based on the user selection.

In an embodiment, the request-related data comprises at least one of a type of the application, a use of requested content by the application, an information associated with access provided to the application based on one or more previous requests, or an information associated with access provided to one or more applications similar to the application.

In an embodiment, the plurality of semantic categories associated with the one or more content types is based on a demographic profile of the user.

In an embodiment, the demographic profile of the user is based on at least one of a location, an age, a sex, race, and user-interests.

In an embodiment, the at least one processor (202) is configured to provide, one or more sub-labels based on the user selection of the at least one label. The at least one processor (202) is configured to receive a user selection of at least one sub-label from the one or more sub-labels corresponding to the one or more content types. The at least one processor (202) is configured to provide, to the application, the access to the one or more content types requested by the application based on the user selection of the at least one sub-label.

In an embodiment, the one or more content types comprises at least one of images, videos, text messages, electronic device information, and sensors-related data.

In an embodiment, the at least one processor (202) is configured to learn user preferences based on user selections of the at least one label for one or more access requests for one or more content types by the application. The at least one processor (202) is configured to update the one or more semantic categories for the one or more content types based on the user preferences.

In an embodiment, the at least one processor (202) is configured to determine a rank associated with each of the plurality of labels associated with each of the one or more content types requested by the application based on the learned user preferences. The at least one processor (202) is configured to provide the one or more labels associated corresponding to each one of the one or more content types based on the determined rank corresponding to each label.

In an embodiment, the at least one processor (202) is configured to monitor an actual content type accessed by the application. The at least one processor (202) is configured to determine whether the actual content type is different from the provided access to the one or more content types. The at least one processor (202) is configured to determine a spurious access by the application to alert the user in response to determining that the actual content type accessed by the application is different than the provided access to the one or more content types. The at least one processor (202) is configured to display the determined spurious access by the application.

In an embodiment, the at least one processor (202) is configured to determine a type of the application based on one or more metadata associated with the application. The at least one processor (202) is configured to restrict access to a set of content type for the application based on the type of application.

In an embodiment, the at least one processor (202) is configured to receive, from the application, a sensor access request to access one or more sensors of the electronic device. The at least one processor (202) is configured to determine sensor request related data corresponding to the sensor access request by the application. The at least one processor (202) is configured to determine whether the sensor request related data complies with a predefined criteria to access the one or more sensors. The at least one processor (202) is configured to provide, to the application, an access to the one or more sensors requested by the application upon determining that the sensor request related data complies with the predefined criteria to access the one or more sensors.

In an embodiment, the at least one processor (202) is configured to monitor the access of the one or more sensors by the application. The at least one processor (202) is configured to determine whether the application is in use by the user while accessing the one or more sensors. The at least one processor (202) is configured to restrict the access to the one or more sensors by the application in response to determining that the application is not in use by the user while accessing the one or more sensors.

In an embodiment, the at least one processor (202) is configured to generate an alert for the user upon determining that the application is not in use by the user while accessing the one or more sensors.

In an embodiment, the at least one processor (202) is configured to generate pseudo content based on the one or more content type requested by the application. The at least one processor (202) is configured to provide access to the pseudo content to the application.

The present disclosure provides an application permission model based on semantic content classification. The present disclosure may facilitate selecting content-based permissions for an application. The present disclosure may also facilitate permission recommendations for the user based on the application, requested access and user demographic profile. The disclosure may increase privacy while using an application. By logging access information from the application, the disclosure may also reduce data synchronization by the application to the server. The disclosure may reduce the risk of data misuse while providing data cleaning functionalities that may facilitate removal of data from the electronic device.

While language has been used to describe the present subject matter, any limitations arising on account thereto, are not intended. As would be apparent to a person in the art, various modifications may be made to the method within the scope of the disclosure. The drawings and the foregoing description give examples of embodiments. Those skilled in the art will appreciate that one or more of the described elements may be combined into a single functional element. Certain elements may be split into multiple functional elements. Elements from one embodiment may be added to another embodiment.

What is claimed is:

1. A method for managing access to content for an application of an electronic device, the method comprising:
receiving, from the application, a content access request for granting access to first data of one or more content types available via the electronic device;
displaying one or more labels, from among a plurality of labels, corresponding to the one or more content types;
receiving a first user selection of at least one label, from among the one or more labels, corresponding to the one or more content types; and
granting, to the application, access to the first data of the one or more content types based on the first user selection.

2. The method as claimed in claim 1, further comprising:
displaying one or more sub-labels based on the first user selection;
receiving a second user selection of at least one sub-label, from among the one or more sub-labels, corresponding to at least one of the one or more content types; and
granting, to the application, access to second data of the at least one of the one or more content types based on the second user selection.

3. The method as claimed in claim 1, wherein the one or more content types comprise at least one of images, videos, text messages, electronic device information, or sensor data.

4. The method as claimed in claim 1, further comprising:
monitoring a content type of second data accessed by the application;
determining whether the content type deviates from the access granted;
detecting a spurious access by the application based on the content type deviating from the access granted; and
displaying a notification indicating the spurious access.

5. The method as claimed in claim 1, further comprising:
determining an application type based on metadata associated with the application; and
restricting the access to second data from among a set of one or more content types based on the application type.

6. The method as claimed in claim 1, further comprising:
receiving, from the application, a sensor access request to access one or more sensors of the electronic device;
determining second data corresponding to the sensor access request by the application;
determining whether the second data complies with a predefined criteria for accessing the one or more sensors; and
providing, to the application, access to the one or more sensors based on determining that the second data complies with the predefined criteria.

7. The method as claimed in claim 6, further comprising:
monitoring the access to the one or more sensors by the application;
determining whether the application is in use by a user of the electronic device while the one or more sensors are being accessed by the application; and
based on determining the application is not in use, restricting the access to the one or more sensors by the application.

8. The method as claimed in claim 7, further comprising:
displaying a notification based on the application not being in use by the user while the one or more sensors are being accessed by the application.

9. The method as claimed in claim 1, further comprising:
generating pseudo content based on the one or more content types; and
providing the application access to the pseudo content.

10. An electronic device for managing access to content for an application, the electronic device comprising:
memory storing instructions; and
at least one processor;
wherein the instructions, when executed by the at least one processor, cause the electronic device to:
receive, from the application, a content access request for granting access to first data of one or more content types available via the electronic device;
display one or more labels, from among a plurality of labels, corresponding to the one or more content types;
receive a first user selection of at least one label, from among the one or more labels, corresponding to the one or more content types; and
granting, to the application, access to the first data of the one or more content types based on the first user selection.

11. The electronic device as claimed in claim 10, wherein the instructions, when executed by the at least one processor, cause the electronic device to:
display one or more sub-labels based on the first user selection;
receive a second user selection of at least one sub-label, from among the one or more sub-labels, corresponding to at least one of the one or more content types; and
grant, to the application, access to second data of the at least one of the one or more content types based on the second user selection.

12. The electronic device as claimed in claim 10, wherein the one or more content types comprise at least one of images, videos, text messages, electronic device information, or sensor data.

13. The electronic device as claimed in claim 10, wherein the instructions, when executed by the at least one processor, cause the electronic device to:
monitor a content type of second data accessed by the application;
determine whether the content type deviates from the access granted;
detecting a spurious access by the application based on the content type deviating from the access granted; and
display a notification indicating the spurious access.

14. The electronic device as claimed in claim 10, wherein the instructions, when executed by the at least one processor, cause the electronic device to:
determine an application type based on metadata associated with the application; and
restrict the access to second data from among a set of one or more content types based on the application type.

15. The electronic device as claimed in claim 10, wherein the instructions, when executed by the at least one processor, cause the electronic device to:
receive, from the application, a sensor access request to access one or more sensors of the electronic device;
determine second data corresponding to the sensor access request by the application;
determine whether the second data complies with a predefined criteria for accessing the one or more sensors; and
provide, to the application, access to the one or more sensors based on determining that the second data complies with the predefined criteria.
